(19) United States
(12) Patent Application Publication
(10) Pub. No.: US 2010/0320958 A1
(43) Pub. Date: Dec. 23, 2010

(54) Photovoltaic shell for rechargeable batteries

(76) Inventor: Marina Kawitt, Chicago, IL (US)

Correspondence Address: MARINA KAWITT, 6550 WEST BELMONT AVENUE 108, CHICAGO, IL, 60634, US

(21) Appl. No.: 12/802,119

(22) Filed: May 29, 2010

Related U.S. Application Data
(60) Provisional application No. 61/268,832, filed on Jun. 17, 2009.

(51) Int. Cl. H01M 10/46

(52) U.S. Cl. 320/101

(57) ABSTRACT

Photovoltaic shell for charging a rechargeable battery. Photovoltaic shell includes flexible photovoltaic cells wrapped around a rechargeable battery cell. Positive terminal of photovoltaic cells are connected to positive terminal of rechargeable battery cell, and negative terminal of photovoltaic cells are connected to negative terminal of rechargeable battery cell, to provide charge while exposed to light.

### BACKGROUND OF THE INVENTION

1. Field of the Invention

The present invention relates to solar cell chargers and more specifically it relates to photovoltaic charging shell in rechargeable batteries by providing flexibility to charge and use batteries anywhere, in electronic devices.

2. Description

Rechargeable battery wrapped in solar cells not only convenient source of energy that can be used anywhere away from power sources, but also a reliable tool for an emergency situations. It has same flexibility as regular conventional battery.

3. Advantages

Free of outlet and other electrical sources.

Keeps all its capacity.

Charges fully only at 50% of sunlight.

Always stays charged and prolongs battery life.

Still can be charged by regular/non-solar battery charger.

Short time period to fully charge under the sun.

### SUMMARY OF THE INVENTION

A primary object of the present invention is to provide a photovoltaic shell for rechargeable batteries that will be convenient to charge batteries without any electrical power source.

Another object is to provide photovoltaic shell for rechargeable battery as reliable and always charged source of energy in emergency situations.

An additional object is to provide photovoltaic shell for rechargeable battery; to prolong life and multi use, and to reduce frequent recycling of batteries.

A further object is to provide photovoltaic shell for rechargeable battery that is simple and easy to use.

A still further object is to provide photovoltaic shell for rechargeable battery that is economical in cost to manufacture.

### BRIEF DESCRIPTION OF THE DRAWINGS

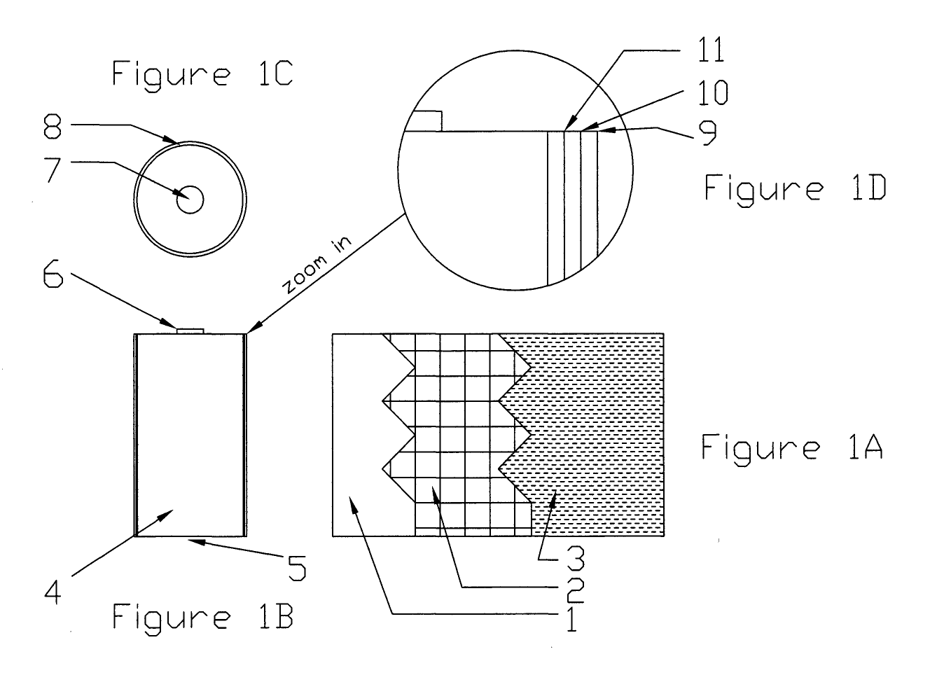

Drawings, page 1 of 2 shows side view (FIG. 1B) and top view (FIG. 1C) of the battery cell wrapped in photovoltaic cells, and unwrapped view of the 3 layers (FIG. 1A); layer of clear plastic, layer of photovoltaic cells, and layer of insulation.

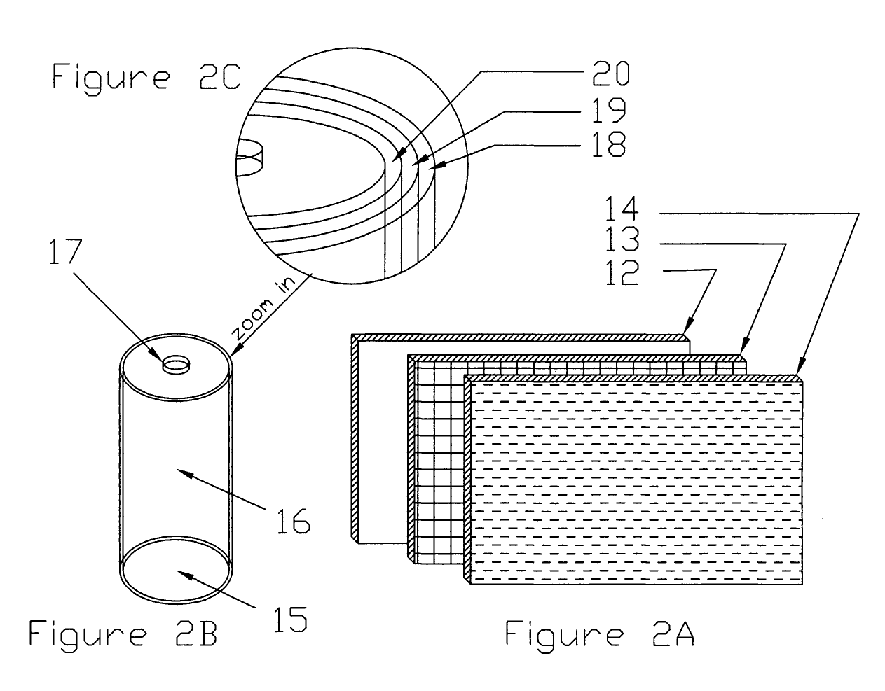

Drawings, page 2 of 2 shows 3-dimensional view of the battery cell wrapped in photovoltaic cells (FIG. 2B), and 3-dimensional unwrapped view of the 3 layers (FIG. A2); layer of clear plastic, layer of photovoltaic cells, and layer of insulation.

Drawings, page 1 and page 2 uses conventional battery as an example, where invention is not limited to its shape or size.

### DESCRIPTION OF THE PREFERRED EMBODIMENTS

Drawings, page 1 of 2 describes detailed structure of the unwrapped photovoltaic shell (1,2,3) for rechargeable battery cell (4). Rechargeable battery (4) covered by three layers; first it is covered by thin layer of insulation (3) about 0.2 mm thin to protect any contact between battery (4) and photovoltaic cells (2), then it is covered by thin layer of photovoltaic cells (2) about 0.2 mm thin, photovoltaic cells (2) connected to battery (4) with negative to negative terminal (5) and positive to positive terminal (6), then it is covered by thin layer of clear plastic cover (1) to protect body. Rechargeable battery cell (4) is about 2 mm less in diameter without any layers, so these three layers should be less or equal to 2 mm.

### OPERATION OF THE INVENTION

Photovoltaic shell wrapped around rechargeable battery has same functionality as regular, conventional battery, because of its thin layer of insulation and thin layer of photovoltaic cells, it does not affect its shape or size. With just little exposure to daylight, battery cell does not loose its energy over the time period.

### LIST OF REFERENCE NUMBERS

FIG. 1A. 1. Side view of unwrapped layer of clear plastic cover

FIG. 1A. 2. Side view of unwrapped layer of photovoltaic cells

FIG. 1A. 3. Side view of unwrapped layer of non-conductive insulation

FIG. 1B. 4. Side view of rechargeable battery cell

FIG. 1B. 5. Side view of negative terminal of battery cell

FIG. 1B. 6. Side view of positive terminal of battery cell

FIG. 1C. 7. Top view of positive terminal of battery cell

FIG. 1C. 8. Top view of photovoltaic shell

FIG. 1D. 9. Side view zoom of layer of clear plastic cover

FIG. 1D. 10. Side view zoom of layer of photovoltaic cells

FIG. 1D. 11. Side view zoom of layer of non-conductive insulation

FIG. 2A. 12. Three dimensional view of unwrapped clear plastic cover

FIG. 2A. 13. Three dimensional view of unwrapped photovoltaic cells

FIG. 2A. 14. Three dimensional view of unwrapped non-conductive insulation

FIG. 2B. 15. Three dimensional view of negative terminal of battery cell

FIG. 2B. 16. Three dimensional view of rechargeable battery cell

FIG. 2B. 17. Three dimensional view of positive terminal of battery cell

FIG. 2C. 18. Three dimensional zoom view of clear plastic cover

FIG. 2C. 19. Three dimensional zoom view of photovoltaic cells

FIG. 2C. 20. Three dimensional zoom view of non-conductive insulation

1. Photovoltaic shell includes flexible photovoltaic cells wrapped around rechargeable battery cell.

2. Photovoltaic shell as recited in claim 1, wherein the rechargeable battery cell is a lithium battery.

3. Photovoltaic shell as recited in claim 1, wherein the rechargeable battery cell is a nickel magnesium battery.

4. Photovoltaic shell as recited in either claim 2 or claim 3, further comprising photovoltaic cells are wrapped around rechargeable battery cell.

5. Thin layer of insulation used between rechargeable battery cell and photovoltaic cells.

6. Photovoltaic shell as recited in claim 5, wherein the layer of insulation made of non-conductive material.

7. Photovoltaic shell as recited in claim 1, wherein photovoltaic cells made of flexible thin film material.

8. Photovoltaic shell as recited in claim 7, wherein photovoltaic cells are connected in series to achieve required voltage.

9. Photovoltaic shell as recited in claim 7, wherein photovoltaic cells are connected in parallel to achieve required ampers.

10. Photovoltaic shell as recited in claim 4, wherein photovoltaic cells cover at least surface area of rechargeable battery cell.

11. Photovoltaic shell as recited in claim 10, wherein surface area of conventional rechargeable battery cell calculated as circumference multiplied by height.

12. Photovoltaic shell as recited in claim 11, wherein conventional battery cell shape includes D, C, AA, AAA, AAAA sizes.

13. Photovoltaic shell as recited in claim 10, wherein surface area of rectangular shape battery cell calculated as perimeter multiplied by height.

14. Photovoltaic cells connected to rechargeable battery cell with negative to negative and positive to positive terminals.
